(19) United States
(12) Patent Application Publication
(10) Pub. No.: US 2004/0052357 A1
(43) Pub. Date: Mar. 18, 2004

(54) Method and apparatus for processing phone numbers

(75) Inventors: Tim D. Logan, Mountain View, CA (US); John L. McCormick IV, Santa Clara, CA (US)

Correspondence Address: WILSON SONSINI GOODRICH & ROSATI, 650 PAGE MILL ROAD, PALO ALTO, CA, 943041050

(73) Assignee: Xpherix Corporation, San Jose, CA (US)

(21) Appl. No.: 10/622,093

(22) Filed: Jul. 16, 2003

Related U.S. Application Data
(60) Provisional application No. 60/400,061, filed on Jul. 31, 2002.

(51) Int. Cl. H04M 1/00; H04M 3/00

(52) U.S. Cl. 379/355.04

(57) ABSTRACT

Various methods and apparatuses can process phone numbers. Stored phone numbers can be parsed into phone number components. Based at least on the parsing, the stored phone numbers can be corrected. The attempt to correct can be prior to selecting the stored phone numbers to dial.

### CROSS-REFERENCE TO RELATED APPLICATIONS

This application claims the benefit of priority to U.S. Provisional Patent Application Serial No. 60/400,061, which is incorporated herein by reference in its entirety.

### BACKGROUND OF THE INVENTION

Phone number data which has been stored into a PIM such as Outlook, or into other software may not be in a standardized format which is useful to the end user. For example, a stored phone number may not include the country code, under the assumption that the end user of the phone number would be in the same country. Similarly, when stored phone numbers are received from a third party, it is uncertain whether the third party entered and/or stored the phone numbers in a format which is useful. Accordingly, it would be desirable if stored phone numbers could be processed to help ensure successful call completion of the stored phone numbers.

### BRIEF SUMMARY OF THE INVENTION

Some embodiments process phone numbers by parsing stored phone numbers into phone number components; and based at least on the parsing, attempting to correct the stored phone numbers, prior to selecting the stored phone numbers to dial.

Some embodiments also, after attempting to correct the stored phone numbers, make the stored phone numbers available to a user of the stored phone numbers, a computer associated with selecting stored phone numbers to dial, and/or to a mobile phone.

In some embodiments, attempting to correct can be done at least at a computer.

### BRIEF DESCRIPTION OF THE FIGURES

FIG. 1 shows an example of a method of processing a phone number.

FIG. 2 shows an example of a method of processing a phone number which is made available to users.

FIG. 3 shows an example of a method of processing a phone number which is made available to another computer.

FIG. 4 shows an example of a method of processing a phone number which is made available to a mobile phone.

FIG. 5 shows an example of a system in which the processing of phone numbers occurs.

### DETAILED DESCRIPTION OF THE INVENTION

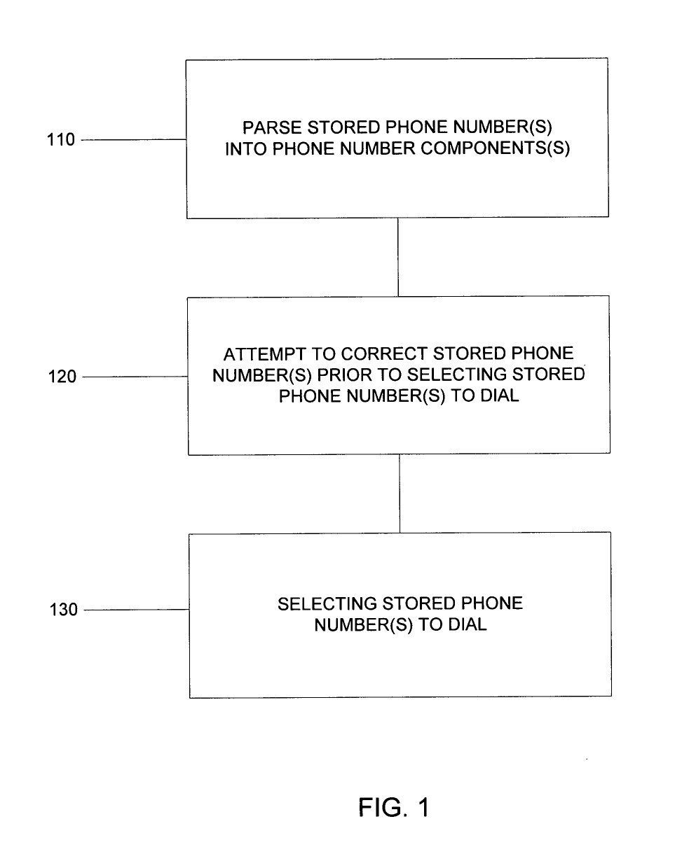

FIG. 1 shows an example of a method of processing a phone number. In 110, one or more stored phone numbers are parsed into one or more phone number components. The phone number components can include a PBX code, an international prefix, a national prefix, a country code, an area code, a subscriber number, and/or an extension. In 120, prior to selecting the phone numbers to dial, the stored phone numbers are corrected. This attempt at correcting can fail or succeed, and is based at least on the parsed phone number components.

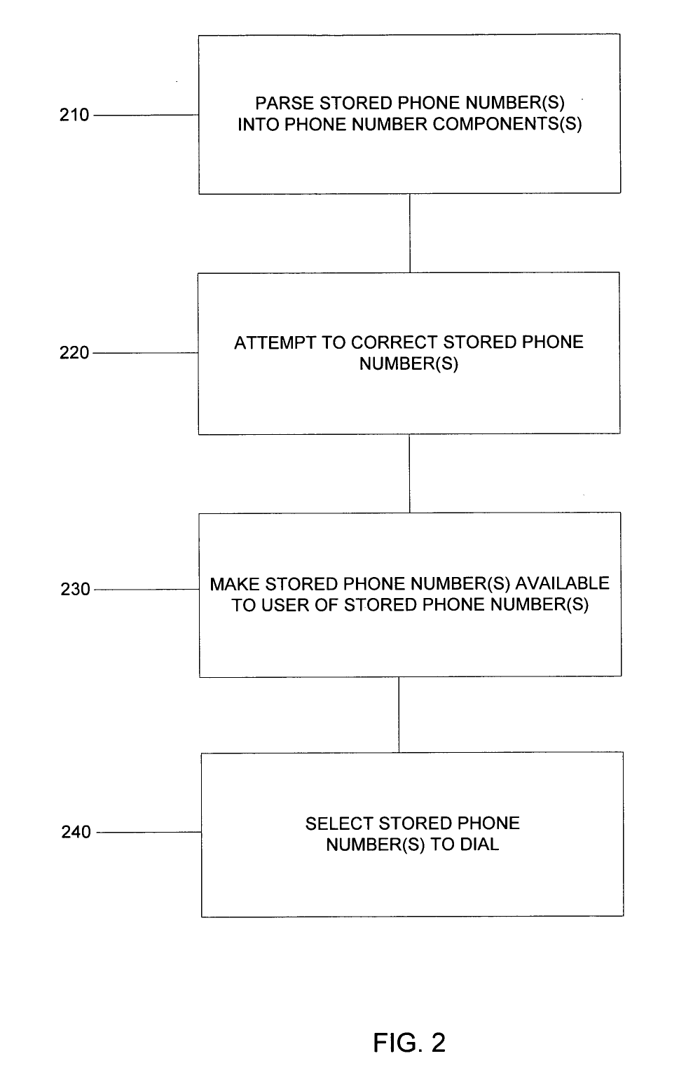

FIG. 2 shows another example of a method of processing a phone number. In 210, one or more stored phone numbers are parsed into one or more phone number components. The phone number components can include a PBX code, an international prefix, a national prefix, a country code, an area code, a subscriber number, and/or an extension. In 220, the stored phone numbers are corrected. This attempt at correcting can fail or succeed, and is based at least on the parsed phone number components. In 230, after attempting to correct the stored phone numbers, the stored phone numbers, which may have been corrected, are made available to a user of the stored phone numbers. In 240, at least one of the stored phone numbers, which may have been corrected, is selected to dial.

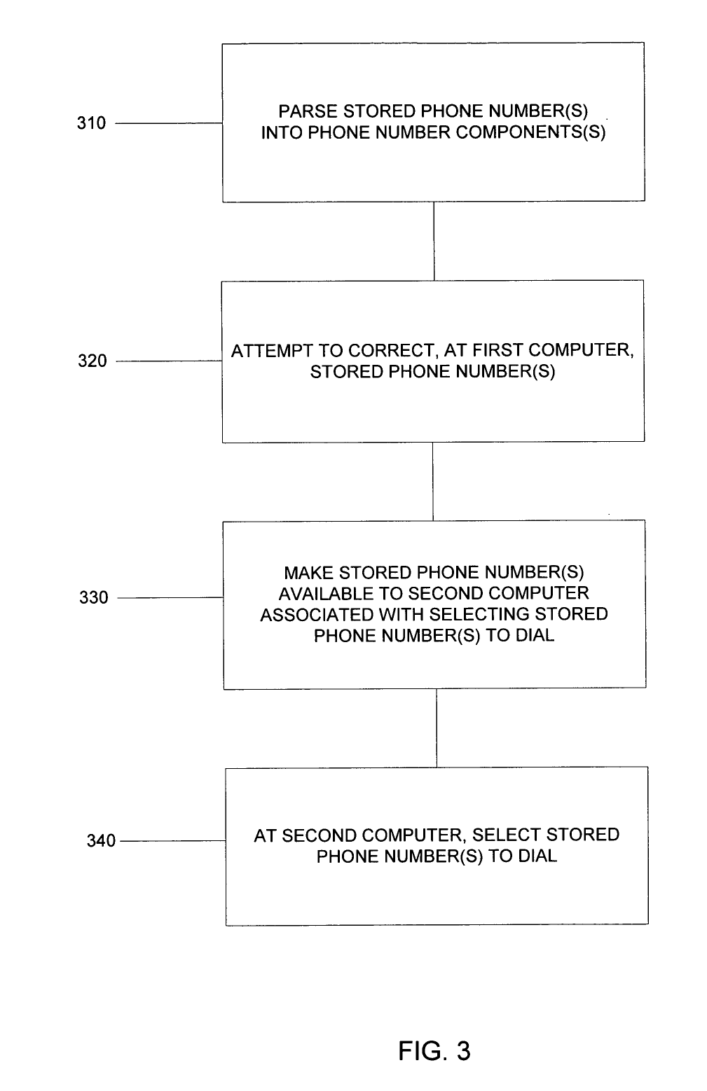

FIG. 3 shows another example of a method of processing a phone number. In 310, one or more stored phone numbers are parsed into one or more phone number components. The phone number components can include a PBX code, an international prefix, a national prefix, a country code, an area code, a subscriber number, and/or an extension. In 320, the stored phone numbers are corrected at a first computer. This attempt at correcting can fail or succeed, and is based at least on the parsed phone number components. In 330, after attempting to correct the stored phone numbers, the stored phone numbers, which may have been corrected, are made available to a second computer. The second computer is associated with selecting the stored phone numbers to dial. In 340, at least one of the stored phone numbers, which may have been corrected, is selected to dial at the second computer.

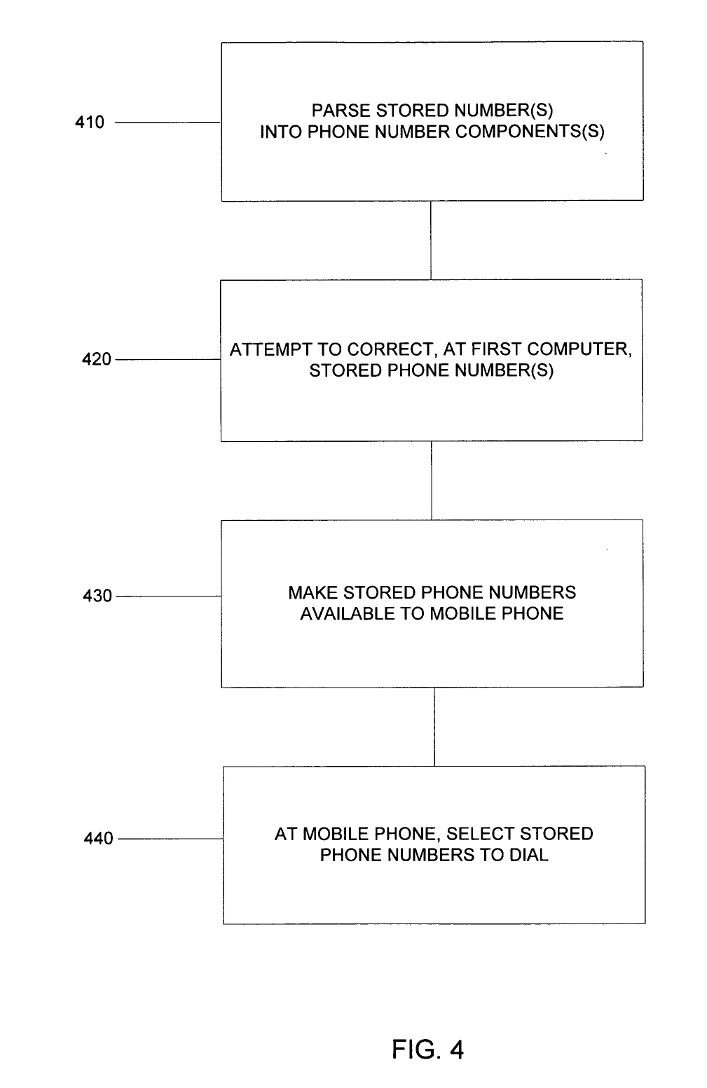

FIG. 4 shows another example of a method of processing a phone number. In 410, one or more stored phone numbers are parsed into one or more phone number components. The phone number components can include a PBX code, an international prefix, a national prefix, a country code, an area code, a subscriber number, and/or an extension. In 420, the stored phone numbers are corrected at a first computer. This attempt at correcting can fail or succeed, and is based at least on the parsed phone number components. In 430, after attempting to correct the stored phone numbers, the stored phone numbers, which may have been corrected, are made available to a mobile phone. In 440, at least one of the stored phone numbers, which may have been corrected, is selected to dial at the mobile phone.

The shown methods are exemplary and parts may be added, removed, modified, and/or rearranged.

The stored phone numbers may be stored on: a computer, such as a computer with a personal information manager; a server of the phone number processor; a server controlled by a third party, such as a directory assistance provider or a carrier; and/or a mobile phone. Stored phone numbers have been recorded in a machine's memory. Stored phone numbers do not include, unstored phone numbers, such as an unstored number remembered from a person's memory and dialed digit-by-digit.

Attempting to correct stored phone numbers can be done in many ways, such as changing undialable phone numbers to dialable phone numbers, identifying invalid phone numbers, determining country codes that are missing from phone numbers, determining area codes that are missing from phone numbers, formatting phone numbers into canonical form, updating area codes of phone numbers based on area code updates, and updating area codes of phone numbers based on geography associated with the phone numbers.

Changing undialable phone numbers to dialable phone numbers can be done in several ways, such as adding an international prefix, adding a national prefix, adding a country code, and/or adding a dial extension. Dialable numbers are valid and have proper dialing logic. An undialable number fails to meet the requirements of a dialable number.

Valid phone numbers have all relevant phone number components of the phone number. An example of the minimum relevant phone number components for a local phone call can be the subscriber number. An example of the maximum relevant phone number components for an international phone call can be the country code, the area code, the subscriber number, and the extension. All the relevant phone number components are of the proper length, and any area code is a legitimate area code for that country code. In some embodiments, a phone number is valid if the phone number has all the relevant phone number components, since a stored phone number may need to be dialed from another systems that have different requirements. For example, from a mobile phone, a call may be a local call and just the subscriber number may be dialed, but if the call is made with directory assistance, the call may be a long-distance call.

Proper dialing logic entails adding any prefixes to a valid number based on the number being called and the location of the caller. For example, if the country code differs between the calling phone and the phone number being called, the international prefix is added and the country code is included.

Identifying invalid phone numbers can be done in several ways, such as identifying phone numbers as having too many digits, too few digits, and/or missing phone number components. A call center and/or a mobile phone user can be notified the invalid phone numbers.

Invalid phone numbers can be missing relevant phone number components (e.g., country code, area code, and/or subscriber number). Also, any of those phone number components may fail to meet length requirements (e.g., as defined by the country code) and/or any of those phone number components can be composed of an invalid digit combination (e.g., 000 for country code 1). In some cases, the area code is not always a required piece, such as for countries that do not have area codes. Some embodiments require the country code and the subscriber number for a number to be valid.

Determining country codes that are missing from phone numbers can be done in many ways. For example, this determination can be based on determining countries of customer portals (such as a portal of a cell phone carrier where the user is registered), and/or from contact data associated with the phone numbers missing country codes (e.g., from database data or from a source of database data, such as PIM data).

Determining area codes that are missing from phone numbers can be done in many ways. For example, this determination can be based on performing reverse lookups from contact data associated with the phone numbers missing area codes (e.g., from database data or from a source of database data, such as PIM data).

Formatting phone numbers into canonical form can be done in many ways. For example, the canonical form can depend countries associated with the phone numbers, the geography within countries associated with the phone numbers, whether the phone numbers are associated with mobile telephony, whether the phone numbers are associated with landline telephony, and/or the numbers of digits following the country codes for the phone numbers.

The canonical form is a standard format based on country code and potentially several other factors, such as specific geography, mobile vs. landline, and/or phone number length. Examples of canonical forms for US numbers are “1 (XXX) XXX-XXXX ext. XXXX,” “1 (XXX) XXX-XXXX,” “(XXX) XXX-XXXX,” “XXX XXXXXXX,” “XXX XXX XXXX,” and other similar combinations with/without extensions, parentheses, country codes, hyphens, etc. This standard format is both aesthetically pleasing (generally matching the standard format for that country), and allows for matching numbers from disparate sources. For example, during registration, a user can register a mobile phone number as an ID for accessing the user's account. When the user logs in, the user may type in the mobile phone number differently (e.g., with/without a country code and/or with/without a national prefix). The data may be passed from the carrier. The process of absolutely and accurately matching multiple numbers is aided by formatting the phone numbers into the same format with the same phone number components, such as canonical form.

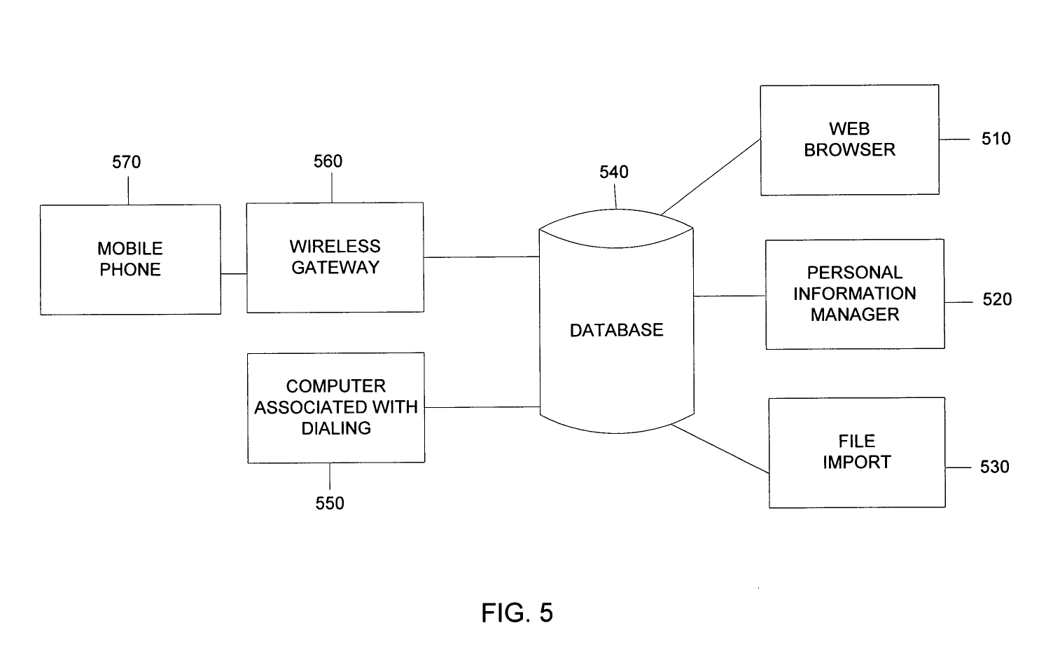

FIG. 5 shows an example of a system in which the processing of phone numbers occurs. The phone numbers can come from sources such as a web browser 510, a personal information manager 520 (for example, Outlook or a handheld contact manager), and file import 530. The database 540 stores the phone numbers. The phone numbers at the database 540 can be used by a computer associated with dialing phone numbers 550. Alternatively, the phone numbers at the database 540 can be sent to a wireless gateway 560 and then to a mobile phone 570. The processing of phone numbers can occur anywhere in the shown system, for example at web browser 510, personal information manager 520, file import 530, database 540, computer 550, wireless gateway 560, mobile phone 570, and/or anywhere in between, such as between database 540 and web browser 510, between database 540 and personal information manager 520, between database 540 and file import 530, between database 540 and computer 550, between database 540 and wireless gateway 560, and/or between mobile phone 570 and wireless gateway 560. Regardless of where the processing occurs, the processed phone numbers can be made available to users, mobile phones, and/or computers via wired and/or wireless connections.

What is claimed is:

1. A method of processing phone numbers, comprising:
parsing one or more stored phone numbers into a plurality of one or more phone number components; and
based at least on the parsing, attempting to correct the one or more stored phone numbers, prior to selecting at least of the one or more stored phone numbers to dial.

2. The method of claim 1, wherein the one or more phone number components include one or more of: a PBX code, an international prefix, a national prefix, a country code, an area code, a subscriber number, and an extension.

3. The method of claim 1, further comprising:
selecting at least one of the one or more stored phone numbers to dial.

4. The method of claim 1, wherein attempting to correct comprises:
changing at least one undialable phone number of the one or more stored phone numbers to at least one dialable phone number.

5. The method of claim 4, wherein changing at least one undialable phone number of the one or more stored phone numbers to at least one dialable phone number includes adding an international prefix.

6. The method of claim 4, wherein changing at least one undialable phone number of the one or more stored phone numbers to at least one dialable phone number includes adding a national prefix.

7. The method of claim 4, wherein changing at least one undialable phone number of the one or more stored phone numbers to at least one dialable phone number includes adding a country code.

8. The method of claim 4, wherein changing at least one undialable phone number of the one or more stored phone numbers to at least one dialable phone number includes adding a dial extension.

9. The method of claim 1, wherein attempting to correct comprises:
identifying one or more invalid phone numbers from the one or more stored phone numbers.

10. The method of 9, further comprising:
notifying a call center of the one or more invalid phone numbers.

11. The method of 9, further comprising:
notifying a mobile phone user of the one or more invalid phone numbers.

12. The method of claim 9, wherein identifying one or more invalid phone numbers from the one or more stored phone numbers includes identifying at least one phone number of the one or more stored phone numbers as having too many digits.

13. The method of claim 9, wherein identifying one or more invalid phone numbers from the one or more stored phone numbers includes identifying at least one phone number of the one or more stored phone numbers as having too few digits.

14. The method of claim 9, wherein identifying one or more invalid phone numbers from the one or more stored phone numbers includes identifying at least one phone number of the one or more stored phone numbers as missing one or more phone number components.

15. The method of claim 1, wherein attempting to correct comprises:
determining one or more country codes missing from one or more phone numbers of the one or more stored phone numbers.

16. The method of claim 15, wherein determining one or more country codes missing from one or more phone numbers of the one or more stored phone numbers includes determining one or more countries of one or more customer portals.

17. The method of claim 15, wherein determining one or more country codes missing from one or more phone numbers of the one or more stored phone numbers includes determining one or more countries from contact data associated with the one or more phone numbers missing one or more country codes.

18. The method of claim 1, wherein attempting to correct comprises:
determining one or more area codes missing from one or more phone numbers of the one or more stored phone numbers.

19. The method of claim 18, wherein determining one or more missing area codes includes performing one or more reverse lookups from contact data associated with the one or more stored phone numbers missing one or more area codes.

20. The method of claim 1, wherein attempting to correct comprises:
formatting, into canonical form, one or more phone numbers from the one or more stored phone numbers.

21. The method of claim 20, wherein the canonical form depends at least one or more countries associated with the one or more phone numbers.

22. The method of claim 21, wherein the canonical form depends at least on geography within one or more countries associated with the one or more phone numbers.

23. The method of claim 20, wherein the canonical form depends at least on whether the one or more phone numbers is associated with mobile telephony.

24. The method of claim 20, wherein the canonical form depends at least on whether the one or more phone numbers is associated with landline telephony.

25. The method of claim 20, wherein the canonical form depends at least on a number of digits following a country code for the one or more phone numbers.

26. The method of claim 1, wherein attempting to correct comprises:
updating one or more area codes of one or more phone numbers from the one or more stored phone numbers, based on at least one area code update.

27. The method of claim 1, wherein attempting to correct comprises:
updating one or more area codes of one or more phone numbers from the one or more stored phone numbers, based on at least geography associated with the one or more phone numbers.

28. A method of processing phone numbers, comprising:
parsing each of the one or more stored phone numbers into a plurality of one or more phone number components;
based at least on the phone number components, attempting to correct the one or more stored phone numbers; and
after attempting to correct, making the one or more stored phone numbers available to a user of the one or more stored phone numbers

29. The method of claim 28, wherein the one or more phone number components include one or more of: a PBX code, an international prefix, a national prefix, a country code, an area code, a subscriber number, and an extension.

30. The method of claim 28, comprising:
selecting, to dial, at least one of the one or more stored phone numbers made available after attempting to correct.

31. The method of claim 28, wherein attempting to correct comprises:
changing at least one undialable phone number of the one or more stored phone numbers to at least one dialable phone number.

32. The method of claim 31, wherein changing at least one undialable phone number of the one or more stored phone numbers to at least one dialable phone number includes adding an international prefix.

33. The method of claim 31, wherein changing at least one undialable phone number of the one or more stored phone numbers to at least one dialable phone number includes adding a national prefix.

34. The method of claim 31, wherein changing at least one undialable phone number of the one or more stored phone numbers to at least one dialable phone number includes adding a country code.

35. The method of claim 31, wherein changing at least one undialable phone number of the one or more stored phone numbers to at least one dialable phone number includes adding a dial extension.

36. The method of claim 28, wherein attempting to correct comprises:
identifying one or more invalid phone numbers from the one or more stored phone numbers.

37. The method of 36, further comprising:
notifying a call center of the one or more invalid phone numbers.

38. The method of 36, further comprising:
notifying a mobile phone user of the one or more invalid phone numbers.

39. The method of claim 36, wherein identifying one or more invalid phone numbers from the one or more stored phone numbers includes identifying at least one phone number of the one or more stored phone numbers as having too many digits.

40. The method of claim 36, wherein identifying one or more invalid phone numbers from the one or more stored phone numbers includes identifying at least one phone number of the one or more stored phone numbers as having too few digits.

41. The method of claim 36, wherein identifying one or more invalid phone numbers from the one or more stored phone numbers includes identifying at least one phone number of the one or more stored phone numbers as missing one or more phone number components.

42. The method of claim 28, wherein attempting to correct comprises:
determining one or more country codes missing from one or more phone numbers of the one or more stored phone numbers.

43. The method of claim 42, wherein determining one or more country codes missing from one or more phone numbers of the one or more stored phone numbers includes determining one or more countries of one or more customer portals.

44. The method of claim 42, wherein determining one or more country codes missing from one or more phone numbers of the one or more stored phone numbers includes determining one or more countries from contact data associated with the one or more phone numbers missing one or more country codes.

45. The method of claim 28, wherein attempting to correct comprises:
determining one or more area codes missing from one or more phone numbers of the one or more stored phone numbers.

46. The method of claim 45, wherein determining one or more missing area codes includes performing one or more reverse lookups from contact data associated with the one or more stored phone numbers missing one or more area codes.

47. The method of claim 28, wherein attempting to correct comprises:
formatting, into canonical form, one or more phone numbers from the one or more stored phone numbers.

48. The method of claim 47, wherein the canonical form depends at least one or more countries associated with the one or more phone numbers.

49. The method of claim 48, wherein the canonical form depends at least on geography within one or more countries associated with the one or more phone numbers.

50. The method of claim 47, wherein the canonical form depends at least on whether the one or more phone numbers is associated with mobile telephony.

51. The method of claim 47, wherein the canonical form depends at least on whether the one or more phone numbers is associated with landline telephony.

52. The method of claim 47, wherein the canonical form depends at least on a number of digits following a country code for the one or more phone numbers.

53. The method of claim 28, wherein attempting to correct comprises:
updating one or more area codes of one or more phone numbers from the one or more stored phone numbers, based on at least one area code update.

54. The method of claim 28, wherein attempting to correct comprises:
updating one or more area codes of one or more phone numbers from the one or more stored phone numbers, based on at least geography associated with the one or more phone numbers.

55. A method of processing phone numbers, comprising:
parsing each of the one or more stored phone numbers into a plurality of one or more phone number components;
based at least on the phone number components, attempting to correct, at least at a first computer, the one or more stored phone numbers; and
after attempting to correct, making the one or more stored phone numbers available to a second computer associated with selecting at least one of the one or more stored phone numbers, to dial.

56. The method of claim 55, wherein the one or more phone number components include one or more of: a PBX code, an international prefix, a national prefix, a country code, an area code, a subscriber number, and an extension.

57. The method of claim 55, comprising:
at the second computer, selecting, to dial, at least one of the one or more stored phone numbers.

58. The method of claim 55, wherein attempting to correct comprises:
changing at least one undialable phone number of the one or more stored phone numbers to at least one dialable phone number.

59. The method of claim 58, wherein changing at least one undialable phone number of the one or more stored phone numbers to at least one dialable phone number includes adding an international prefix.

60. The method of claim 58, wherein changing at least one undialable phone number of the one or more stored phone numbers to at least one dialable phone number includes adding a national prefix.

61. The method of claim 58, wherein changing at least one undialable phone number of the one or more stored phone numbers to at least one dialable phone number includes adding a country code.

62. The method of claim 58, wherein changing at least one undialable phone number of the one or more stored phone numbers to at least one dialable phone number includes adding a dial extension.

63. The method of claim 55, wherein attempting to correct comprises:
identifying one or more invalid phone numbers from the one or more stored phone numbers.

64. The method of 63, further comprising:
notifying a call center of the one or more invalid phone numbers.

65. The method of 63, further comprising:
notifying a mobile phone user of the one or more invalid phone numbers.

66. The method of claim 63, wherein identifying one or more invalid phone numbers from the one or more stored phone numbers includes identifying at least one phone number of the one or more stored phone numbers as having too many digits.

67. The method of claim 63, wherein identifying one or more invalid phone numbers from the one or more stored phone numbers includes identifying at least one phone number of the one or more stored phone numbers as having too few digits.

68. The method of claim 63, wherein identifying one or more invalid phone numbers from the one or more stored phone numbers includes identifying at least one phone number of the one or more stored phone numbers as missing one or more phone number components.

69. The method of claim 55, wherein attempting to correct comprises:
determining one or more country codes missing from one or more phone numbers of the one or more stored phone numbers.

70. The method of claim 69, wherein determining one or more country codes missing from one or more phone numbers of the one or more stored phone numbers includes determining one or more countries of one or more customer portals.

71. The method of claim 69, wherein determining one or more country codes missing from one or more phone numbers of the one or more stored phone numbers includes determining one or more countries from contact data associated with the one or more phone numbers missing one or more country codes.

72. The method of claim 55, wherein attempting to correct comprises:
determining one or more area codes missing from one or more phone numbers of the one or more stored phone numbers.

73. The method of claim 72, wherein determining one or more missing area codes includes performing one or more reverse lookups from contact data associated with the one or more stored phone numbers missing one or more area codes.

74. The method of claim 55, wherein attempting to correct comprises:
formatting, into canonical form, one or more phone numbers from the one or more stored phone numbers.

75. The method of claim 74, wherein the canonical form depends at least one or more countries associated with the one or more phone numbers.

76. The method of claim 75, wherein the canonical form depends at least on geography within one or more countries associated with the one or more phone numbers.

77. The method of claim 74, wherein the canonical form depends at least on whether the one or more phone numbers is associated with mobile telephony.

78. The method of claim 74, wherein the canonical form depends at least on whether the one or more phone numbers is associated with landline telephony.

79. The method of claim 74, wherein the canonical form depends at least on a number of digits following a country code for the one or more phone numbers.

80. The method of claim 55, wherein attempting to correct comprises:
updating one or more area codes of one or more phone numbers from the one or more stored phone numbers, based on at least one area code update.

81. The method of claim 55, wherein attempting to correct comprises:
updating one or more area codes of one or more phone numbers from the one or more stored phone numbers, based on at least geography associated with the one or more phone numbers.

82. A method of processing phone numbers, comprising:
parsing each of the one or more stored phone numbers into a plurality of one or more phone number components;
based at least on the phone number components, attempting to correct, at least at a first computer, the one or more stored phone numbers; and
after attempting to correct, making the one or more stored phone numbers available to a mobile phone.

83. The method of claim 82, wherein the one or more phone number components include one or more of: a PBX code, an international prefix, a national prefix, a country code, an area code, a subscriber number, and an extension.

84. The method of claim 82, comprising:
at the mobile phone, selecting, to dial, at least one of the one or more stored phone numbers.

85. The method of claim 82, wherein attempting to correct comprises:
changing at least one undialable phone number of the one or more stored phone numbers to at least one dialable phone number.

86. The method of claim 85, wherein changing at least one undialable phone number of the one or more stored phone numbers to at least one dialable phone number includes adding an international prefix.

87. The method of claim 85, wherein changing at least one undialable phone number of the one or more stored phone numbers to at least one dialable phone number includes adding a national prefix.

88. The method of claim 85, wherein changing at least one undialable phone number of the one or more stored phone numbers to at least one dialable phone number includes adding a country code.

89. The method of claim 85, wherein changing at least one undialable phone number of the one or more stored phone numbers to at least one dialable phone number includes adding a dial extension.

90. The method of claim 82, wherein attempting to correct comprises:
identifying one or more invalid phone numbers from the one or more stored phone numbers.

91. The method of 90, further comprising:
notifying a call center of the one or more invalid phone numbers.

92. The method of 90, further comprising:
notifying a mobile phone user of the one or more invalid phone numbers.

93. The method of claim 90, wherein identifying one or more invalid phone numbers from the one or more stored phone numbers includes identifying at least one phone number of the one or more stored phone numbers as having too many digits.

94. The method of claim 90, wherein identifying one or more invalid phone numbers from the one or more stored phone numbers includes identifying at least one phone number of the one or more stored phone numbers as having too few digits.

95. The method of claim 90, wherein identifying one or more invalid phone numbers from the one or more stored phone numbers includes identifying at least one phone number of the one or more stored phone numbers as missing one or more phone number components.

96. The method of claim 82, wherein attempting to correct comprises:
determining one or more country codes missing from one or more phone numbers of the one or more stored phone numbers.

97. The method of claim 96, wherein determining one or more country codes missing from one or more phone numbers of the one or more stored phone numbers includes determining one or more countries of one or more customer portals.

98. The method of claim 96, wherein determining one or more country codes missing from one or more phone numbers of the one or more stored phone numbers includes determining one or more countries from contact data associated with the one or more phone numbers missing one or more country codes.

99. The method of claim 82, wherein attempting to correct comprises:
determining one or more area codes missing from one or more phone numbers of the one or more stored phone numbers.

100. The method of claim 99, wherein determining one or more missing area codes includes performing one or more reverse lookups from contact data associated with the one or more stored phone numbers missing one or more area codes.

101. The method of claim 82, wherein attempting to correct comprises:
formatting, into canonical form, one or more phone numbers from the one or more stored phone numbers.

102. The method of claim 101, wherein the canonical form depends at least one or more countries associated with the one or more phone numbers.

103. The method of claim 102, wherein the canonical form depends at least on geography within one or more countries associated with the one or more phone numbers.

104. The method of claim 101, wherein the canonical form depends at least on whether the one or more phone numbers is associated with mobile telephony.

105. The method of claim 101, wherein the canonical form depends at least on whether the one or more phone numbers is associated with landline telephony.

106. The method of claim 101, wherein the canonical form depends at least on a number of digits following a country code for the one or more phone numbers.

107. The method of claim 82, wherein attempting to correct comprises:
updating one or more area codes of one or more phone numbers from the one or more stored phone numbers, based on at least one area code update.

108. The method of claim 82, wherein attempting to correct comprises:
updating one or more area codes of one or more phone numbers from the one or more stored phone numbers, based on at least geography associated with the one or more phone numbers.
